(19) United States
(12) Patent Application Publication
(10) Pub. No.: US 2016/0049788 A1
(43) Pub. Date: Feb. 18, 2016

(54) ELECTRICAL POWER BYPASS TOOL AND METHOD

(71) Applicant: RagingWire Data Centers, Inc., Reno, NV (US)

(72) Inventors: Charles O. Linkhart, Shingle Springs, CA (US); George Macricostas, Incline Village, NV (US); Christopher Thames, Round Hill, VA (US)

(21) Appl. No.: 14/826,992

(22) Filed: Aug. 14, 2015

Related U.S. Application Data
(60) Provisional application No. 62/038,025, filed on Aug. 15, 2014.

(51) Int. Cl. H02J 3/00; H02J 3/10

(52) U.S. Cl. CPC H02J 3/006; H02J 3/10

(57) ABSTRACT

An electrical power bypass tool and a method of bypassing electrical power between a power source and branch circuits. The bypass tool includes a tool input breaker; a source bypass breaker in power-providing connection with the input breaker; one or more tool output breakers in power-receiving connection with the input breaker; a portable structure carrying the input breaker and the output breakers; and one or more branch-circuit bypass breakers in power-receiving connection with the tool output breakers.

### CROSS-REFERENCE TO RELATED APPLICATION

This application claims priority from U.S. Provisional Application Ser. No. 62/038,025 filed Aug. 15, 2014 and titled “Live Transfer of Remote Distribution Unit From One UPS Source to Another Using Portable Equipment,” the entire contents of which are incorporated herein by this reference.

### TECHNICAL FIELD

This application relates generally to electrical power distribution apparatus and methods, and more particularly to apparatus and methods of bypassing electrical power around a power feed to permit maintenance and substitution of power sources and power feeds without disrupting downstream electrical service.

### BACKGROUND

Electrical power distribution systems in commercial and industrial settings such as server farms, factories, shopping centers, hospitals, and the like often include power source panels and branch circuit panels. A power source panel receives electrical power, for example from a commercial utility, a local generator, or an uninterruptible power supply (UPS) which may be powered by storage batteries or some other source. A branch circuit panel receives electrical power from the power source panel, either directly or through a step-down transformer, and provides power to various branch circuits. If a transformer is used, it may be physically located at the power source panel, the branch circuit panel, or another convenient place.

A branch circuit panel feed breaker in the power source panel may control the flow of power from the power source panel to the branch circuit panel. One power source panel may provide power to more than one branch circuit panel, in which case the power source panel contains separate branch circuit panel feed breakers, one for each branch circuit panel. In some instances the power source panel is located within about 50 meters of its branch circuit panels but in other instances there may be more distance between them.

Similarly, a branch circuit panel main breaker in the branch circuit panel receives power from the power source panel and in turn provides power to one or more branch circuits through branch circuit breakers.

Power panels typically have a plurality of circuit-breaker receptacles each of which connects to a power bus. It is therefore possible to insert a breaker into an unused receptacle and thereby connect that breaker to the power bus.

Maintenance and wiring changes are commonly needed in electrical power distribution systems. For example, a malfunction may occur in the wiring between a power source and a branch circuit panel, and such malfunctions must be repaired before they lead to a safety issue or a sudden power failure. As new appliances are added and new branch circuits are installed to service them, it may become necessary to switch a branch circuit panel from one power source panel to another. Also, it may become necessary to replace a UPS with a larger one or to supplement an existing UPS with another one.

### BRIEF SUMMARY OF SOME ASPECTS OF THE DISCLOSURE

The inventors believe that they have identified a need for a safe, easy-to-use way to temporarily isolate power feed wiring between a branch circuit panel and a power source panel, and to disconnect the branch circuit panel from an existing power source and connect it to a new one, without causing any disruption in power being provided through branch circuits. In one aspect, this need is met by an electrical power bypass tool having a tool input breaker, one or more tool output breakers in power-receiving connection with the tool input breaker, a portable structure enclosing the tool input breaker and the tool output breakers, a source bypass breaker in power-providing connection with the tool input breaker, and one or more branch-circuit bypass breakers in power-receiving connection with the tool output breakers.

In some embodiments the tool input breaker and tool output breakers may be omitted and in this case the source bypass breaker is in power-proving communication directly with the one or more branch-circuit bypass breakers.

In some embodiments the portable structure includes a power transformer, for example a step-down transformer, connected between the tool input and output breakers. A transformer bypass switch may be connected between the tool input breaker and the tool output breakers with the power transformer connected in power-receiving connection with the bypass switch.

In some embodiments a flexible power line provides a power-providing connection between the source bypass breaker and the tool input breaker. Similarly, one or more flexible power lines may be used to connect the tool output breakers with the branch-circuit bypass breakers, each power line connecting one tool output breaker with one branch-circuit bypass breaker. Flexible power lines facilitate plugging the source bypass breaker into an unused breaker receptacle in the power source panel, and plugging the branch-circuit bypass breakers into unused receptacles in the branch circuit panel.

In some embodiments the portable structure is physically heavy and bulky enough that moving it about may be difficult, especially for only one person. The structure may be equipped with wheels or a handle or both so that one person can easily move it about to wherever it may be needed in a power distribution facility.

In another aspect, an electrical power bypass tool includes first and second source bypass breakers, first and second tool input breakers connected to the first and second source bypass breakers, respectively, and a selector switch in power-receiving connection with the first and second tool input breakers. One or more tool output breakers receive power-from the selector switch, in some embodiments through a power transformer. One or more branch-circuit bypass breakers are in power-receiving connection with the tool output breakers. A portable structure, which may be mounted on wheels and may include a handle, carries one or more of the tool input breakers, the selector switch, the power transformer and transformer bypass switch if provided, and the tool output breakers. The portable structure may take the form of a cabinet that encloses some or all of these components. In some embodiments the portable structure may take the form of a wheeled platform that carries some or all of the components.

In some embodiments the selector switch comprises a static transfer switch that enables a power feed to be switched from one source to another with no perturbation in power flow. If one source bypass breaker is plugged into one power source panel, the other source bypass breaker is plugged into another power source panel, and the branch-circuit bypass breakers plugged into a branch circuit panel, a power feed into the branch circuit panel can be switched from one power source panel to the other by using a static transfer switch without any disruption in power to the branch circuits.

Another embodiment provides a method of bypassing electrical power between a power source panel and a branch circuit panel. The method begins with installing a source bypass breaker in the source panel and one or more branch-circuit bypass breakers in the branch circuit panel, the source bypass breaker being in power-providing connection with the branch-circuit bypass breakers. In some embodiments this may be done by using a bypass tool such as described above, with tool input and output breakers in the power path between the source bypass breaker and the branch-circuit bypass breakers. The source bypass breaker is switched ON. If power is not present at the one or more branch-circuit bypass breakers, power is provided by correcting or changing the wiring as needed. If electrical power provided by the existing power source is polyphase, and if the phase is not correct at the branch-circuit bypass breakers, the phase is corrected by changing the wiring as needed. The branch-circuit bypass breakers are switched ON. A source breaker in the power source panel and a branch circuit panel breaker in the branch circuit panel are both switched OFF, thereby removing all power from a power feed between the source and branch circuit panels. Any desired wiring task, for example a repair of the power feed, is performed. The branch circuit panel breaker and source breaker are switched ON, the branch-circuit breakers and the source bypass breaker are switched OFF, and finally the branch-circuit bypass breakers and the source bypass breaker are uninstalled.

In some installations there will be several or many branch circuits in the branch circuit panel. The number of branch-circuit bypass breakers need not be the same as the number of branch circuits, so long as the total power-providing capacity of all the branch-circuit bypass breakers is at least as great as the total power need of all the branch circuits. In some embodiments a single branch-circuit bypass breaker suffices. In other embodiments several branch-circuit bypass breakers are provided and in a given instance as many of them as are needed to provide the required power are installed in the branch circuit panel.

In some embodiments a bypass transformer in the portable bypass tool must itself be bypassed (disconnected) if there is no transformer between the existing source panel and the branch circuit panel.

Some embodiments include connecting a neutral in the branch circuit panel to a neutral in the bypass tool, for example with a jumper wire.

In another aspect, a method of changing an electrical power feed for a branch circuit panel from a first power source panel to a second power source panel includes:
(1) installing a first source bypass breaker in the first source panel and a second source bypass breaker in the second source panel;
(2) installing a branch-circuit bypass breaker in the branch circuit panel, the branch-circuit bypass breaker in power-receiving connection with the first source bypass breaker and in power-providing connection with a power bus in the branch circuit panel;
(3) switching ON the first and second source bypass breakers;
(4) determining whether power is present at the branch-circuit bypass breaker, and if not, causing power to be provided by correcting any incorrect wiring;
(5) if electrical power provided by the first power source is polyphase, determining whether phase is correct at the branch-circuit bypass breaker, and if not, correcting the phase by correcting any incorrect wiring;
(6) switching the branch-circuit bypass breaker ON in electrical parallel with the first power source;
(7) switching OFF a source breaker in the first power source panel and a branch circuit panel main breaker in the branch circuit panel;
(8) switching power to the branch-circuit bypass breaker from the first source bypass breaker to the second source bypass breaker;
(9) performing any desired wiring task including changing the power connection of the branch circuit panel from the first source panel to the second source panel;
(10) switching ON a source breaker in the second power source panel and the branch circuit panel main breaker;
(11) switching OFF all bypass breakers; and
(12) uninstalling all bypass breakers.

Other aspects and advantages will become apparent from the attached drawings and the following description, illustrating by example the principles of the invention. The scope of the invention is to be determined by reference to the scope of the claims as issued, and not by reason of whether the subject matter addresses or includes an issue, feature, or aspect recited in the Background or in this Brief Summary.

### BRIEF DESCRIPTION OF THE DRAWINGS

The applicants' best mode and additional embodiments are disclosed in association with the accompanying Drawings in which:

FIG. 1 is a schematic and partial perspective view of an embodiment of an electrical power bypass tool including a bypass transformer, the tool shown in electrical connection with an existing power source panel and a branch circuit panel;

FIG. 2 is a schematic and partial perspective view of another embodiment of an electrical power bypass tool in electrical connection with an existing power source panel and a branch circuit panel similar to the embodiment of FIG. 1 but without a bypass transformer;

FIG. 3 is a schematic and partial perspective view of another embodiment of an electrical power bypass tool in electrical connection with an existing power source panel and a branch circuit panel, similar to the embodiment of FIG. 1 and also including a switch for bypassing (disconnecting) the bypass transformer;

FIG. 4 is a schematic and partial perspective view of an embodiment of an electrical power bypass tool including a transfer switch and a bypass transformer, the tool shown in electrical connection with first and second existing power source panels and a branch circuit panel;

FIG. 5 is a flowchart illustrating an embodiment of a method of bypassing electrical power between a power source and a branch circuit panel; and

FIG. 6 is a flowchart illustrating an embodiment of a method of changing a branch circuit power feed from one power source to another with no interruption in power.

### DETAILED DESCRIPTION

Illustrative examples and details are used in the drawings and in this description, but other configurations may exist and may suggest themselves. Parameters such as voltages, temperatures, dimensions, and component values are approximate. For clarity, some known methods and structures have not been described in detail. Methods defined by the claims may comprise steps in addition to those listed, and except as indicated in the claims themselves the steps may be performed in another order than that given.

Electrical power distribution systems often need maintenance or modifications as parts wear out and as needs change. New appliances may be added, requiring additional power. Loads among various power sources may need to be rebalanced. Defective parts may need to be repaired or replaced. Performing such tasks safely requires that power be disconnected, but this is disruptive to users of equipment that is powered through the system. Any interruption of power to critical electronic hardware such as servers and telecommunication equipment in server farms could cause serious disruption and must be avoided. There has been a need for a way to make repairs and changes in power distribution systems without interrupting power being provided to users. The power bypass tools and methods described herein provide a novel and economical solution to this need.

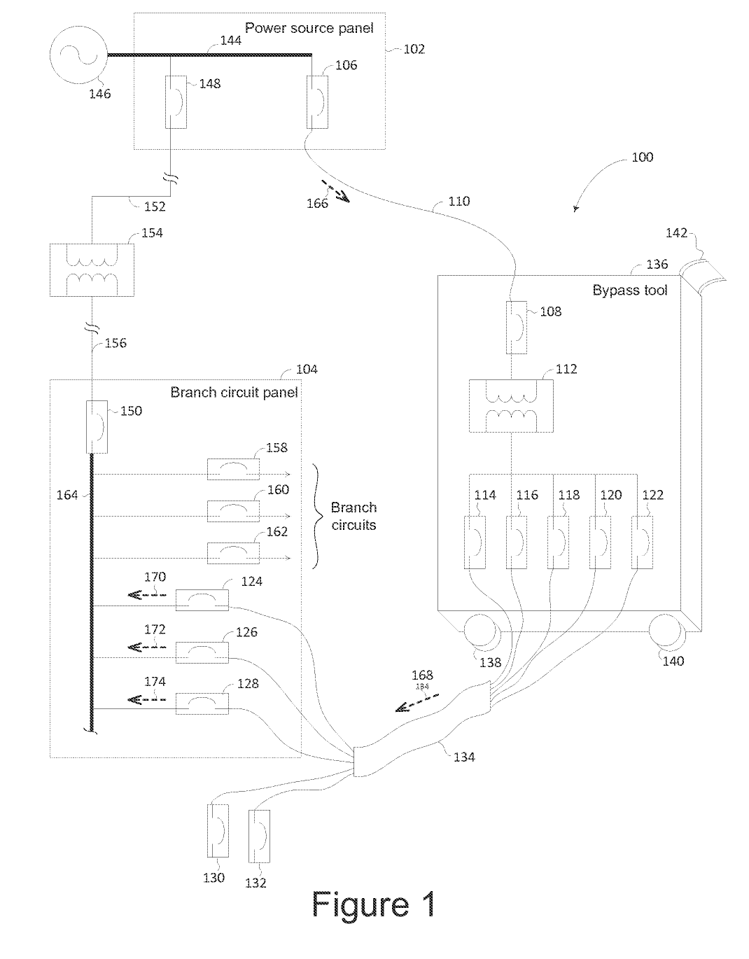

FIG. 1 illustrates an embodiment of an electrical power bypass tool generally 100 connected to a power source panel 102 and a branch circuit panel 104. The tool 100 includes a source bypass breaker 106; a tool input breaker 108; a power-carrying connection 110 between the source bypass breaker 106 and the tool input breaker 108; a bypass transformer 112 connected to receive power from the tool input breaker 108; one or more tool output breakers 114, 116, 118, 120, and 122 connected to receive power from the bypass transformer 112; one or more branch-circuit bypass breakers 124, 126, 128, 130, and 132; and a power-carrying connection 134 from the tool output breakers 114, 116, 118, 120, and 122 to the branch-circuit bypass breakers 124, 126, 128, 130, and 132, respectively.

A portable structure 136 carries the tool input breaker 108, the bypass transformer 112, and the tool output breakers 114, 116, 118, 120, and 122. In some embodiments the portable structure 136 may comprise a cabinet that encloses one or more of the tool input breaker, the bypass transformer, and the tool output breakers. The portable structure 136 may include a plurality of wheels 138 and 140 so that it may conveniently be moved about by one person in a power distribution center even if it is too heavy for one person to pick up and carry. One or more of the wheels may be free castering. The portable structure 136 may be equipped with a handle 142 or other device to facilitate moving it from place to place.

The power-carrying connection 110 between the source bypass breaker 106 and the tool input breaker 108 may be a flexible power line. This power line is depicted in FIG. 1 as a single conductor, but it may actually comprise several conductors. For example, it may carry single-phase power with hot, neutral, and ground conductors, in which case the breakers 106 and 108 may comprise single-pole switching for the hot line or double-pole switching for the hot and neutral lines. Or the power line may carry three-phase power in a delta or wye configuration with three or more conductors, in which case the breakers 106 and 108 may comprise multi-pole switching.

In some embodiments the power-carrying connection 110 comprises one or more flexible conductors, for example copper wires enclosed in flexible steel sheathing, flexible non-metallic sheathing, Romex, SO-type cable, or the like. This facilitates moving the source bypass breaker 106 from one power source panel to another as desired, for example by unplugging it from a circuit-breaker receptacle in one panel and plugging it in to an unused receptacle in another panel.

Similarly, the power-carrying connection 134 between the tool output breakers and the branch-circuit bypass breakers may comprise a plurality of conductors, each conductor connecting one of the tool output breakers with one of the branch-circuit bypass breakers. As noted above, if the bypass breakers are polyphase there will be more than one physical conductor for each such breaker. In the embodiment shown in FIG. 1, these conductors are shown as a multi-conductor flexible cable but in other embodiments the conductors might not be cabled together, or several cables may be used, one for each tool output breaker 114, 116, 118, 120, and 122.

The power source panel 102 has a power bus 144 with a connection that extends out of the panel 102 to an external electrical power source 146. The electrical power source 146 may be public utility power, a local generator, a UPS, or other suitable source of electric power. A source breaker 148 receives electrical power from the power bus 144 and provides the power to a branch circuit panel main breaker 150 in the branch circuit panel 104 through a power conductor 152, a source transformer 154, and a power conductor 156.

The source transformer 154 may be physically located in the power source panel 102, the branch circuit panel 104, or some other convenient place. The source transformer 154 and the bypass transformer 112 may each comprise one or several windings as needed. In some embodiments these transformers are step-down transformers.

The branch circuit panel 104 includes one or more branch circuit breakers 158, 160, and 162 each of which receives power from the branch circuit panel main breaker 150 through a power bus 164 and provides power to a different branch circuit. Although three branch circuit breakers are shown, there may be fewer or more depending on the capacity of the bypass circuits and the load on the branch circuit panel.

When the source bypass breaker 106 is plugged into an empty breaker slot in the power source panel 102, it receives power from the bus 144. When the branch-circuit bypass breakers 124, 126, and 128 are plugged into empty breaker slots in the branch circuit panel 104, electrical power can flow from the power bus 144 through the source bypass breaker 106, the tool input breaker 108, the tool output breakers 114, 116, and 118, and the branch-circuit bypass breakers 124, 126, and 128 to the branch circuit panel bus 164 and thence to the existing branch circuit breakers 158, 160, and 162. Then the source breaker 148 and the branch-circuit panel breaker 150 can be switched off to remove all power from the power conductors 152 and 156 and the source transformer 154 so that modifications, repair, or other service can be safely performed on any of these components while the branch circuits continue to receive power through the bypass tool without disruption.

The bypass tool is shown with five tool output breakers and five branch-circuit bypass breakers. In other embodiments more or fewer may be provided as desired. There must be enough branch-circuit bypass breakers to carry as much power as is required by all the branch circuits combined. Therefore, the higher the power-carrying capacity (the higher the amperage) of each branch-circuit bypass breaker, the fewer such breakers will be needed. In the embodiment shown in FIG. 1, the combined power-carrying capacity of the branch-circuit bypass breakers 124, 126, and 128 must be at least as great as the power required by all three branch circuits. For example, if the first branch circuit breaker 128 is rated at 10 amps, the second breaker 160 is rated at 20 amps, and the third breaker 162 is rated at 30 amps, then the total power capacity required by all the branch circuits would be the sum of those three amperage ratings, or 60 amps total. This can be provided by three branch-circuit bypass breakers such as the breakers 124, 126, and 128 provided the total power-carrying capacity of the three breakers is at least 60 amps. If each of the breakers 124, 126, and 128 is rated at 20 amps, this condition is satisfied. It could also be satisfied by using only two branch-circuit bypass breakers each rated at 30 amps, or four each rated at 15 amps, or one rated at 60 amps, and so on. Therefore there is no requirement that the number of branch-circuit bypass breakers be the same as the number of branch circuits; it may be less, the same, or more, depending on the total power required by all the branch circuits and the power capacity of each branch-circuit bypass breaker. Of course, each branch-circuit bypass breaker must be supplied with power through a conductor, and from a tool output breaker, having enough power-handling capacity.

Arrows 166, 168, 170, 172, and 174 give a visual indication of the direction of power flow from the bus 144 through the bypass tool to the bus 164.

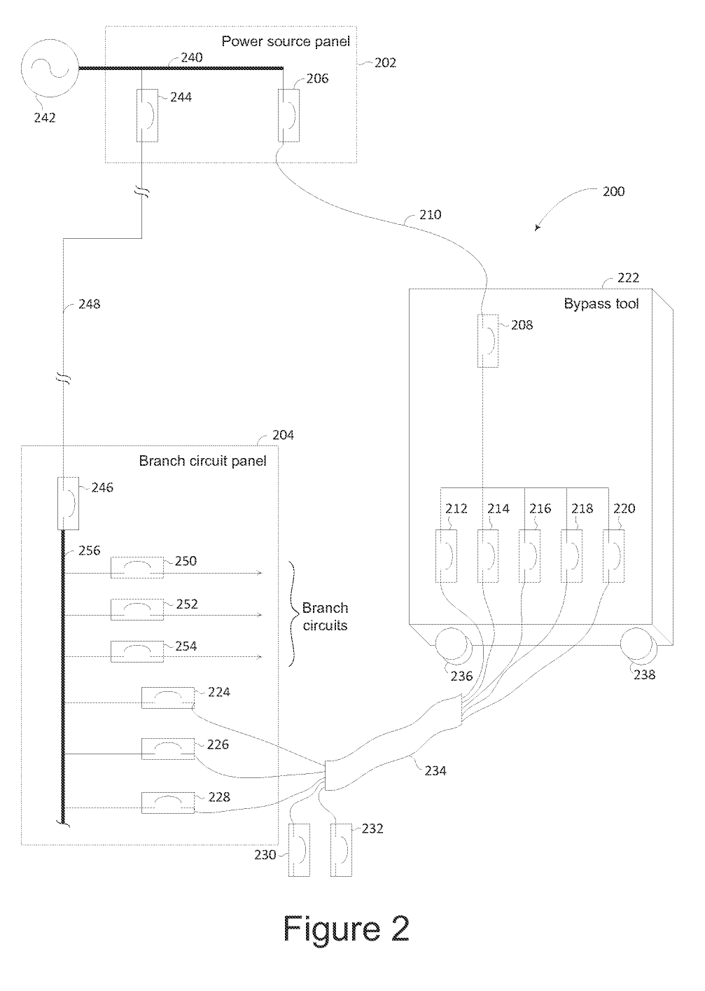

FIG. 2 illustrates another embodiment of an electrical power bypass tool generally 200. This embodiment is generally similar to the one previously discussed but does not have a bypass transformer or a source transformer.

The bypass tool 200 is connected to a power source panel 202 and a branch circuit panel 204. The tool 200 includes a source bypass breaker 206; a tool input breaker 208; a power-carrying connection 210 between the source bypass breaker 206 and the tool input main breaker 208; one or more tool output breakers 212, 214, 216, 218, and 220 connected to receive power from the tool input main breaker 208; a portable structure 222 enclosing the tool input breaker and the tool output breakers; one or more branch-circuit bypass breakers 224, 226, 228, 230, and 232; and a power-carrying connection 234 between the tool output breakers and the branch-circuit bypass breakers.

The portable structure 222 may include a plurality of wheels 236 and 238. As with the embodiment of FIG. 1, the structure 222 may include a handle (not shown).

The power source panel 202 has a power bus 240 with a connection that extends out of the panel 202 to an external electrical power source 242 similar to the power source 146 of FIG. 1. A source breaker 244 receives electrical power from the power bus 240 and provides the power to a branch circuit panel main breaker 246 in the branch circuit panel 204 through a power conductor 248.

The branch circuit panel 204 includes one or more branch circuit breakers 250, 252, and 254, each of which receives power from the branch circuit panel main breaker 246 through a power bus 256 and provides power to a different branch circuit.

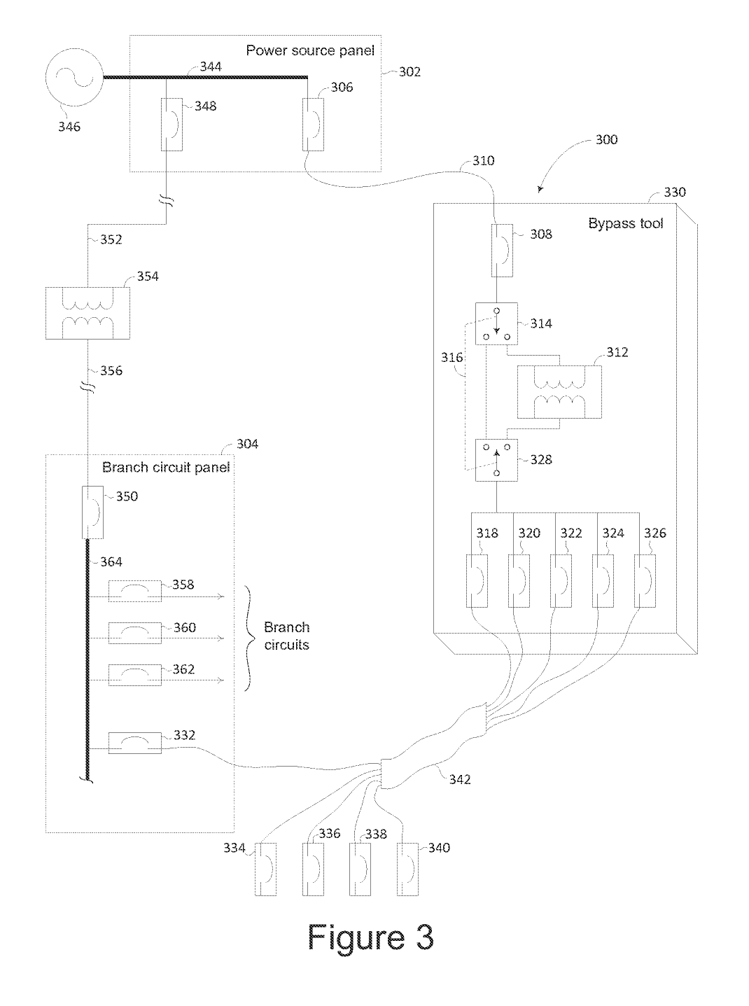

FIG. 3 illustrates another embodiment of an electrical power bypass tool generally 300. This embodiment is generally similar to the one previously discussed with reference to FIG. 1, but this embodiment includes switches 314 and 328 whereby a bypass transformer may be switched in or out of the bypass circuit as desired.

The electrical power bypass tool 300 is connected to a power source panel 302 and a branch circuit panel 304. The tool 300 includes a source bypass breaker 306; a tool input breaker 308; a power-carrying connection 310 between the source bypass breaker 306 and the tool input breaker 308; a bypass transformer 312 connected to receive power from the tool input breaker 308 through a first pole 314 of a double-pole double-throw (DPDT) switch 316; one or more tool output breakers 318, 320, 322, 324, and 326 connected to receive power from the bypass transformer 312 through a second pole 328 of the DPDT switch 316; a portable structure 330 that includes the tool input breaker, the bypass transformer, the DPDT switch, and the tool output breakers; one or more branch-circuit bypass breakers 332, 334, 336, 338, and 340; and a power-carrying connection 342 between the tool output breakers and the branch-circuit bypass breakers.

The power source panel 302 has a power bus 344 with a connection that extends out of the panel 302 to an external electrical power source 346 similar to the power source 146 of FIG. 1. A source breaker 348 receives electrical power from the power bus 344 and provides the power to a branch circuit panel breaker 350 in the branch circuit panel 304 through a power conductor 352, a source transformer 354, and a power conductor 356.

The branch circuit panel 304 includes one or more branch circuit breakers 358, 360, and 362 each of which receives power from the branch circuit panel breaker 350 through a power bus 364 and provides power to a different branch circuit. As in the previously-discussed embodiments, although three branch-circuit breakers are shown, there may be fewer or more depending on how many branch circuits there are.

In this embodiment only one branch-circuit bypass breaker 332 is shown plugged into the branch circuit panel 304 and with a connection to the power bus 364. Provided this branch-circuit bypass breaker 332, and its associated tool output breaker 318, are rated for enough power for all the branch circuits, this type of connection will function satisfactorily. If one branch-circuit bypass breaker's capacity is not adequate for the entire branch circuit panel's load, multiple bypass circuits (one or more of 334, 336, 338, and 340) are connected to bus 364 in parallel, with an aggregate capacity to carry the whole panel's load

The bypass tool 300 may be used either with a branch circuit panel that receives electrical power through a transformer or with a branch circuit panel that receives power directly from the power source panel; the DPDT switch 316 being used to switch the bypass transformer in or out of the circuit as needed. Other embodiments of the bypass tool might include two or more transformers each with different voltage or power ratings and appropriate switches, so that the bypass tool might be used with power systems of different voltages or power capacities.

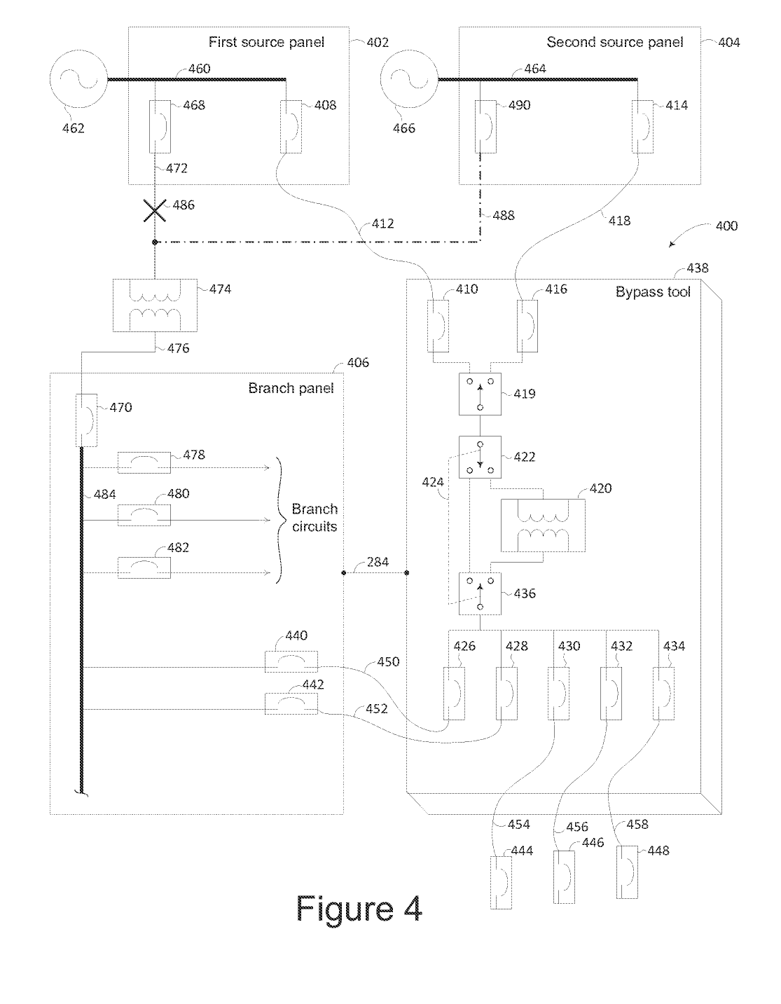

FIG. 4 illustrates another embodiment of an electrical power bypass tool generally 400. This embodiment is generally similar to the ones previously discussed, but this embodiment includes a feature whereby the bypass tool can receive power from either of two source power panels. This enables it to be used not only to bypass power around a circuit being worked on but also to switch a branch circuit panel from one power source to another so that source wiring to the branch circuit panel can safely be changed without disrupting power to the branch circuits.

The bypass tool 400 is connected to a first power source panel 402, a second power source panel 404, and a branch circuit panel 406. The tool 400 includes a first source bypass breaker 408, a first tool input breaker 410, and a first power-carrying connection 412 between the first source bypass breaker 408 and the first tool input breaker 410. Similarly, the tool 400 includes a second source bypass breaker 414, a second tool input breaker 416, and a second power-carrying connection 418 between the second source bypass breaker 414 and the second tool input breaker 416. A selector switch 419, which may be for example a static transfer switch enabling perturbation-free switching between the two power sources, receives power from the tool input breakers 410 and 416.

The bypass tool 400 includes a bypass transformer 420 connected to receive power from the selector switch 419 through a first pole 422 of a double-pole double-throw (DPDT) switch 424; one or more tool output breakers 426, 428, 430, 432, and 434 connected to receive power from the bypass transformer 420 through a second pole 436 of the DPDT switch 424; and a portable structure 438 enclosing the tool input breakers, the selector switch, the bypass transformer, the DPDT switch, and the tool output breakers. In some embodiments there may be no need to change voltage levels, and in such cases the bypass transformer 420 and the switch 424 are omitted.

The bypass tool 400 includes one or more branch-circuit bypass breakers 440, 442, 444, 446, and 448. It includes a power-carrying connection 450 from the tool output breaker 426 to the branch-circuit bypass breaker 440; a power-carrying connection 452 from the tool output breaker 428 to the branch-circuit bypass breaker 442; a power-carrying connection 454 from the tool output breaker 430 to the branch-circuit bypass breaker 444; a power-carrying connection 456 from the tool output breaker 432 to the branch-circuit bypass breaker 446; and a power-carrying connection 458 from the tool output breaker 434 to the branch-circuit bypass breaker 448. As described above respecting other embodiments, there could be more or fewer branch-circuit bypass breakers as needed.

In this embodiment two branch-circuit bypass breakers, 440 and 442, are shown as having been plugged into unused breaker receptacles in the branch panel 406. So long as these two breakers together can provide enough power for all of the branch circuits, this connection will provide satisfactory operation. If the branch circuits require more power, then one or more of the branch-circuit bypass breakers 444, 446, and 448 would also be plugged into unused breaker receptacles in the branch panel 406 to provide the needed power to the bus 484 and from there to the branch circuits.

In this embodiment these power-carrying connections 450, 452, 454, 456, and 458 are shown as individual conductors. As with other embodiments, each connection may actually include one or several wires as needed, and they may be flexible for convenience in moving the branch-circuit bypass breakers from one branch circuit panel to another. The connections may be cabled together or (as shown) independent of each other.

The first power source panel 402 has a power bus 460 with a connection that extends out of the panel 402 to a first external electrical power source 462. Similarly, the second power source panel 404 has a power bus 464 with a connection that extends out of the panel 404 to a second external electrical power source 466. The power sources 462 and 466 may be different main circuits from public utility power, or one may be utility power and the other a generator, a UPS, or the like, or both may be local power sources other than utility power.

A first source breaker 468 receives electrical power from the power bus 460 and provides the power to a branch circuit panel main breaker 470 in the branch circuit panel 406 through a power conductor 472, a source transformer 474, and a power conductor 476. First, second, and third branch circuit breakers 478, 480, and 482 receive power from the branch circuit panel breaker 470 through a branch panel power bus 484 and provide power to their respective branch circuits.

If it is desired that the branch circuit panel 406 receive power from the second power source 466 rather than the first power source 462, for example for load-balancing purposes, the power conductor 472 must be disconnected as indicated by an “X” 486 and in its place a new power conductor 488 must be installed from a second source breaker 490 in the second source panel 404 to the transformer 474. This change can easily be accomplished by using the bypass tool to bypass the power to the branch circuits so that the first source breaker 468, the second source breaker 490, and the branch circuit panel main breaker 470 can all be turned OFF, removing all power from the transformer 474 and the conductors 472 and 476. Then the conductor 472 can be removed and the new conductor 488 installed.

In more detail, the process begins by plugging the first source bypass breaker 408 into an empty breaker receptacle in the first source panel 402, and plugging the branch-circuit-bypass breakers 440 and 442 into empty breaker receptacles in the branch circuit panel 406. A flow of electrical power from the first source panel 402 through the bypass tool to the branch circuits is established in a manner similar to that described previously for other embodiments. Then the branch circuit panel main breaker 470 is opened. Any time after the branch circuit panel main breaker 470 is opened, the second source bypass breaker 414 and the bypass tool input breaker 416 can be closed. Then static switch 419 is used to transfer the power feed to the branch circuit panel 406 from the first power source 460 (through the first source bypass breaker 408) to the second power source 464 (through the second source breaker 414). Then the first power source breaker 468 can be opened, the power conductor 472 removed, and the new power conductor 488 installed. Then the second source breaker 490 and the branch circuit panel main breaker 470 can be closed, energizing the branch circuit panel from the new power source 466. At this point the bypass tool can be removed by opening the branch-circuit bypass breakers 440 and 442, turning OFF the first and second source bypass breakers 408 and 414, removing the conductors 412 and 418 by unplugging the source bypass breakers, and unplugging the branch-circuit bypass breakers 440 and 442. The bypass tool once uninstalled can be used again elsewhere in the power distribution facility, either to repair a power circuit (in which case the second source bypass breaker 414 and the second tool input breaker 416 would not be used) or to perform another power-switching connection.

Throughout the foregoing, any reference to plugging a bypass breaker into an unused or empty receptacle also includes temporarily using spare circuit breakers that are already in place. For example, in FIG. 4, instead of providing the branch-circuit-panel bypass breaker 440 as a separate breaker to be plugged into an unused receptacle in the branch panel, the conductor 450 could be connected to a spare breaker that is already in the branch circuit panel. Similarly, spare breakers in the source panels 402 and 404 could be used in place of the bypass breakers 408 and 414.

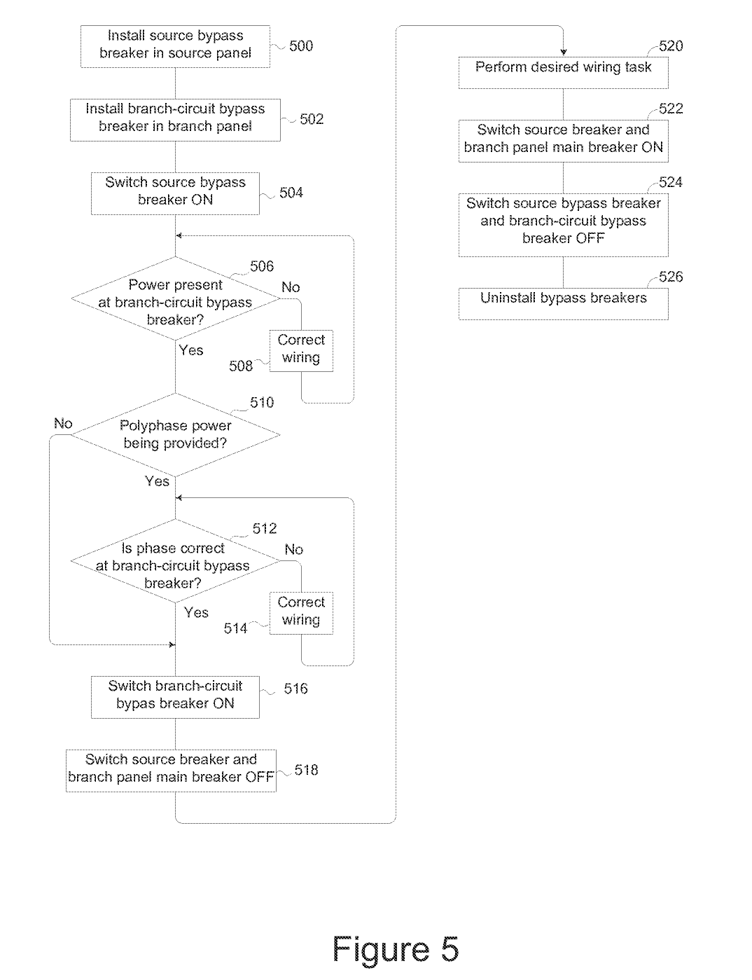

FIG. 5 shows an embodiment of a method of bypassing electrical power between a power source panel and a branch circuit panel. The method includes: installing a source bypass breaker in the power source panel (500); installing one or more branch-circuit bypass breakers in the branch circuit panel (502); switching the source bypass breaker ON (504); determining whether power is present at the branch-circuit bypass breaker (506), and if not, causing power to be provided by correcting any incorrect wiring (508) and returning to again determine whether power is present; if polyphase power is being provided (510), determining whether phase is correct at the branch-circuit bypass breaker (512), and if not, correcting the phase by correcting any incorrect wiring (514) and returning to again determine whether the phase is correct; switching the branch-circuit bypass breaker ON (516); switching the source breaker and the branch circuit panel main breaker OFF (518); performing any desired wiring task (520); switching the source breaker and the branch circuit panel main breaker ON (522); switching the source bypass breaker and branch-circuit bypass breaker OFF (524); and uninstalling the bypass breakers (526).

If a bypass power transformer is connected between the source bypass breaker and the branch-circuit bypass breaker, it may be necessary to disconnect (bypass) such transformer if there is no power transformer in the power feed between the source panel and the branch circuit panel.

In some installations the branch circuit panel may have a neutral connection, and for reasons of electrical safety or for other purposes it may be desirable or essential to connect that neutral connection with a corresponding neutral connection associated with the bypass breakers. For example, if part of the wiring connecting the bypass breakers is contained in a cabinet, the cabinet may provide a neutral terminal, or the cabinet frame itself may be used as a neutral.

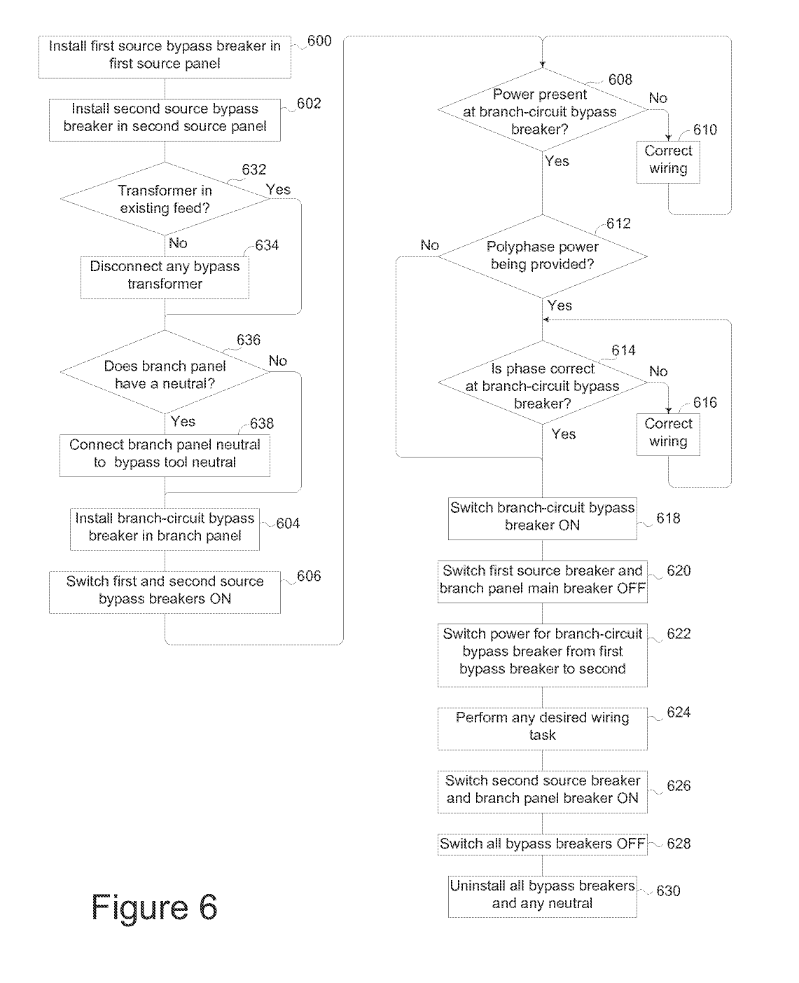

FIG. 6 shows an embodiment of a method of switching an electrical power input of a branch circuit panel from a first power source panel to a second power source panel. The method includes: installing a first source bypass breaker in the first power source panel (600); installing a second source bypass breaker in the second source panel (602); installing one or more branch-circuit bypass breakers in the branch circuit panel (604); switching the first and second source bypass breakers ON (606); determining whether power is present at the branch-circuit bypass breaker (608), and if not, causing power to be provided by correcting any incorrect wiring (610) and returning to again determine whether power is present; if polyphase power is being provided (612) and if the phase is not correct at the branch-circuit bypass breaker (614), correcting the phase by correcting any incorrect wiring (616) and returning to again determine whether phase is correct; switching the branch-circuit bypass breaker ON (618); switching the first source breaker and the branch panel main breaker OFF (620); switching the power for the branch-circuit bypass breaker from the first source bypass breaker to the second source bypass breaker (622); performing any desired wiring task, for example disconnecting the power feed from the first source panel to the branch circuit panel and connecting a power feed from the second source panel to the branch circuit panel (624); switching the second source breaker and the branch circuit panel main breaker ON (626); switching all bypass breakers OFF (628); and uninstalling all bypass breakers (630).

It is not necessary that the second source bypass breaker be switched ON at the same time as the first one (606). The second source bypass breaker can be switched ON at any time from when it has been installed (602) until the branch-circuit bypass breaker needs to draw power from it (622).

If a bypass power transformer is provided between the source bypass breakers and the branch-circuit bypass breaker, and if there is no power transformer in the power feed between the first source panel and the branch circuit panel (632), the bypass transformer must itself be bypassed (disconnected) (634). In some embodiments this is accomplished by switching both the primary winding and the secondary winding of the bypass transformer out of the circuit, but in other embodiments only the primary is switched off and the secondary remains connected whether or not the bypass transformer is being used.

In some embodiments the foregoing method is practiced with a bypass tool of the kind described above. If a bypass tool is used, and if the branch circuit panel has a neutral connection (636), it may be desirable or essential to connect the branch panel neutral to a neutral connection in the bypass tool or in some embodiments to a neutral point such as a frame of the bypass tool (638).

The power bypass tools and methods as described above solve the problem of how to perform maintenance, repairs, and modifications of electrical power distribution systems without interrupting power being provided to users. This is especially valuable as respects appliances such as computer servers in server farms and medical devices in hospitals that must not suffer power interruptions, not even short-term ones.

The disclosure is not to be limited by anything in the foregoing description and the attached drawings, which illustrate embodiments and aspects by example, but only by the claims.

I claim:

1. An electrical power bypass tool comprising:
a tool input breaker;
a source bypass breaker in power-providing connection with the input breaker;
one or more tool output breakers in power-receiving connection with the input breaker;
a portable structure that carries the input breaker and the output breakers; and
one or more branch-circuit bypass breakers in power-receiving connection with the tool output breakers.

2. The electrical power bypass tool of claim 1 and further comprising a bypass power transformer connected between the tool input breaker and the tool output breakers.

3. The electrical power bypass tool of claim 1 and further comprising a power transformer and a transformer bypass switch, the transformer bypass switch connected between the tool input breaker and the tool output breakers and the power transformer connected in power-receiving connection with the transformer bypass switch.

4. The electrical power bypass tool of claim 1 wherein the power-providing connection between the source bypass breaker and the tool input breaker comprises a flexible power line.

5. The electrical power bypass tool of claim 1 wherein the power-receiving connection between the branch-circuit bypass breakers and the tool output breakers comprises a plurality of flexible power lines, each power line connecting one branch-circuit bypass breaker with one tool output breaker.

6. The electrical power bypass tool of claim 1 wherein the portable structure comprises a plurality of wheels and a cabinet carried by the wheels, the cabinet enclosing the tool input and output breakers.

7. An electrical power bypass tool comprising:
first and second tool input breakers;
an input selector in power-receiving connection with the tool input breakers;
first and second source bypass breakers in power-providing connection with the first and second tool input breakers, respectively;
one or more tool output breakers in power-receiving connection with the input selector;
a portable structure that carries the tool input breakers, the input selector, and the tool output breakers; and
one or more branch-circuit bypass breakers each in power-receiving connection with a different one of the tool output breakers.

8. The electrical power bypass tool of claim 7 wherein the power-providing connection between the first source bypass breaker and the first tool input breaker comprises a flexible power line.

9. The electrical power bypass tool of claim 7 wherein the power-receiving connection between the branch-circuit bypass breakers and the tool output breakers comprises a plurality of flexible power lines, each power line connecting one branch-circuit bypass breaker with one tool output breaker.

10. The electrical power bypass tool of claim 7 and further comprising:
a transformer bypass switch connected between the input selector and the tool output breakers; and
a power transformer in electrical communication with the transformer bypass switch.

11. The electrical power bypass tool of claim 7 wherein the input selector comprises a static transfer switch.

12. The electrical power bypass tool of claim 7 wherein the portable structure comprises a plurality of wheels and a cabinet carried by the wheels, the cabinet enclosing the tool input and output breakers.

13. A method of bypassing electrical power between a source panel and a branch circuit panel, the method comprising:
(1) installing a source bypass breaker in the source panel in power-providing connection between the source panel and a branch-circuit bypass breaker;
(2) installing a branch-circuit bypass breaker in the branch circuit panel, the branch-circuit bypass breaker in power-providing connection between the source bypass breaker and a power bus in the branch circuit panel;
(3) switching ON the source bypass breaker;
(4) determining whether power is present at the branch-circuit bypass breaker, and if not, causing power to be provided by correcting any incorrect wiring;
(5) if electrical power provided by the power source is polyphase, determining whether phase is correct at the branch-circuit bypass breaker, and if not, correcting the phase by correcting any incorrect wiring;
(6) switching the branch-circuit bypass breaker ON;
(7) switching OFF a source breaker in the source panel and a branch circuit panel main breaker in the branch circuit panel;
(8) performing any desired wiring task;
(9) switching ON the branch circuit panel main breaker and the source breaker;
(10) switching OFF the branch-circuit bypass breaker and the source bypass breaker; and
(11) uninstalling the bypass breakers.

14. The method of claim 13 wherein step (2) comprises installing a plurality of branch-circuit bypass breakers.

15. The method of claim 13 and further comprising disconnecting a bypass power transformer if there is no power transformer between the source breaker and the branch circuit panel breaker.

16. The method of claim 13 and further comprising connecting a neutral in the branch circuit panel to a neutral associated with the bypass breakers.

17. A method of changing an electrical power feed for a branch circuit panel from a first power source panel to a second power source panel, the method comprising:
(1) installing a first source bypass breaker in the first source panel and a second source bypass breaker in the second source panel;
(2) installing a branch-circuit bypass breaker in the branch circuit panel, the branch-circuit bypass breaker in power-receiving connection with the first source bypass breaker and in power-providing connection with a power bus in the branch circuit panel;
(3) switching ON the first and second source bypass breakers;
(4) determining whether power is present at the branch-circuit bypass breaker, and if not, causing power to be provided by correcting any incorrect wiring;
(5) if electrical power provided by the first power source is polyphase, determining whether phase is correct at the branch-circuit bypass breaker, and if not, correcting the phase by correcting any incorrect wiring;
(6) switching the branch-circuit bypass breaker ON;
(7) switching OFF a source breaker in the first power source panel and a branch circuit panel main breaker in the branch circuit panel;
(8) switching power to the branch-circuit bypass breaker from the first source bypass breaker to the second source bypass breaker;
(9) performing any desired wiring task including changing the power connection of the branch circuit panel from the first source panel to the second source panel;
(10) switching ON a source breaker in the second power source panel and the branch circuit panel main breaker;
(11) switching OFF all bypass breakers; and
(12) uninstalling all bypass breakers.

18. The method of claim 17 wherein step (2) comprises installing a plurality of branch-circuit bypass breakers.

19. The method of claim 17 and further comprising bypassing a bypass power transformer connected between the source bypass breakers and the branch-circuit bypass breaker if there is no transformer between the first source panel and the branch circuit panel.

20. The method of claim 17 and further comprising connecting a neutral in the branch circuit panel to a neutral in the bypass tool.
